(19) United States
(12) Patent Application Publication
(10) Pub. No.: US 2009/0024700 A1
(43) Pub. Date: Jan. 22, 2009

(54) AD TARGETING USING REFERENCE PAGE INFORMATION

(75) Inventors: Ashutosh Garg, Sunnyvale, CA (US); Kedar Dhamdhere, Sunnyvale, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/176,288

(22) Filed: Jul. 18, 2008

Related U.S. Application Data
(60) Provisional application No. 60/950,858, filed on Jul. 19, 2007.

(51) Int. Cl. G06F 15/16

(52) U.S. Cl. 709/203

(57) ABSTRACT

Methods, systems, and apparatus, including computer program products, for sponsored content targeting. A request for providing sponsored content to be associated with source content provided by a page publisher is received. A source of a referral to the source content is evaluated. Sponsored content is selected based on the evaluation.

### RELATED APPLICATION

This application claims the benefit under 35 U.S.C. §119 of U.S. Provisional Application No. 60/950,858, titled “AD TARGETING USING REFERENCE PAGE INFORMATION,” filed Jul. 19. 2007, which is incorporated by reference herein in its entirety.

### BACKGROUND

The subject matter of this specification is related generally to advertising.

Interactive media (e.g., the Internet) has great potential for improving the targeting of advertisements (“ads”) to receptive audiences. For example, some websites provide information search functionality that is based on keywords entered by the user seeking information. This user query can be an indicator of the type of information of interest to the user. By comparing the user query to a list of keywords specified by an advertiser, it is possible to provide targeted ads to the user.

Another form of online advertising is ad syndication, which allows advertisers to extend their marketing reach by distributing ads to additional partners. For example, third party online publishers can place an advertiser's text or image ads on web properties with desirable content to drive online customers to the advertiser's website. The specific advertisements that can be displayed on the web properties of the third party online publisher can be selected based on the content of the web properties. For example, advertisements for computers or computer service can be selected for presentation in a web property that includes computing-related content.

### SUMMARY

In general, one aspect of the subject matter described in this specification can be embodied in methods that include the actions of receiving a request for providing sponsored content to be associated with source content provided by a page publisher, evaluating a source of a referral to the source content, and selecting the sponsored content based on the evaluation. Other implementations of this aspect include corresponding systems, apparatus, and computer program products.

Implementations of this aspect can include the following features. Evaluating the source of the referral to the source content can include evaluating content of a page in which the referral to the source content is located. Evaluating the source of the referral to the source content can include evaluating anchor content associated with the referral to the source content. The anchor content can include anchor text. The anchor content can include an anchor image. Content in proximity to the anchor content can be evaluated. The content in proximity to the anchor content can include text. Text that is a predetermined distance from a location associated with the anchor content can be evaluated. The predetermined distance can be a predetermined number of words in a same line or in a same sentence. The predetermined distance can be a predetermined number of characters before or after the anchor content. The predetermined number of characters can be 5. The predetermined distance can be a predetermined number of words before or after the anchor content. The predetermined number of words can be 5. Metadata associated with the anchor content can be evaluated. The source content can be evaluated, and the evaluations of the source content and of the source of the referral to the source content can be used to select the sponsored content. A result of an evaluation of the source content and a result of an evaluation of the source of the referral to the source content can be weighted to determine a selection of the sponsored content. A result of the evaluation of the source of the referral to the source content can be used along with one or more other criteria to select sponsored content. The other criteria can be defined by a page publisher or the sponsored content provider.

In general, another aspect of the subject matter described in this specification can be embodied in methods that include the actions of sourcing content source material including one or more portions therein available to be populated by sponsored content; embedding within the content source material a call to a sponsored content server; causing to be delivered to the sponsored content server an identifier for a content source material requester and information related to a referrer of the content source material to the content source material requestor; and responding to a page request to deliver the content source material including providing the content source material, including the embedded call to the content source material requester. Other implementations of this aspect include corresponding systems, apparatus, and computer program products.

In general, another aspect of the subject matter described in this specification can be embodied in methods that include the actions of requesting content from a publisher including providing a content request to the publisher, where the content request includes sourcing information indicating a context of the requester; and receiving and displaying the content from the publisher and sponsored content that is selected at least in part based on the sourcing information. Other implementations of this aspect include corresponding systems, apparatus, and computer program products.

Implementations of this aspect can include the following features. The sourcing information can include anchor content. The sourcing information can include content in proximity to the anchor content. The anchor content can include anchor text. The sourcing information can include text in proximity to the anchor text.

Particular implementations of the subject matter described in this specification can be implemented to realize one or more of the following advantages. Advertisements can be selected based on the content of a page that refers a user to the page where the advertisements will be displayed. The referral page provides context to the user's online navigation, which can be used to select advertisements.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online advertising system.

FIG. 2A is an example user interface of a browser displaying anchor text.

FIG. 2B is an example user interface of a browser displaying anchor images.

FIG. 3 is a flow diagram of an example sponsored content targeting process.

FIG. 4 is a flow diagram of an example context evaluating process.

FIG. 5 is a schematic diagram of an example generic computer system.

Like reference numbers and designations in the various drawings indicate like elements.

### DETAILED DESCRIPTION

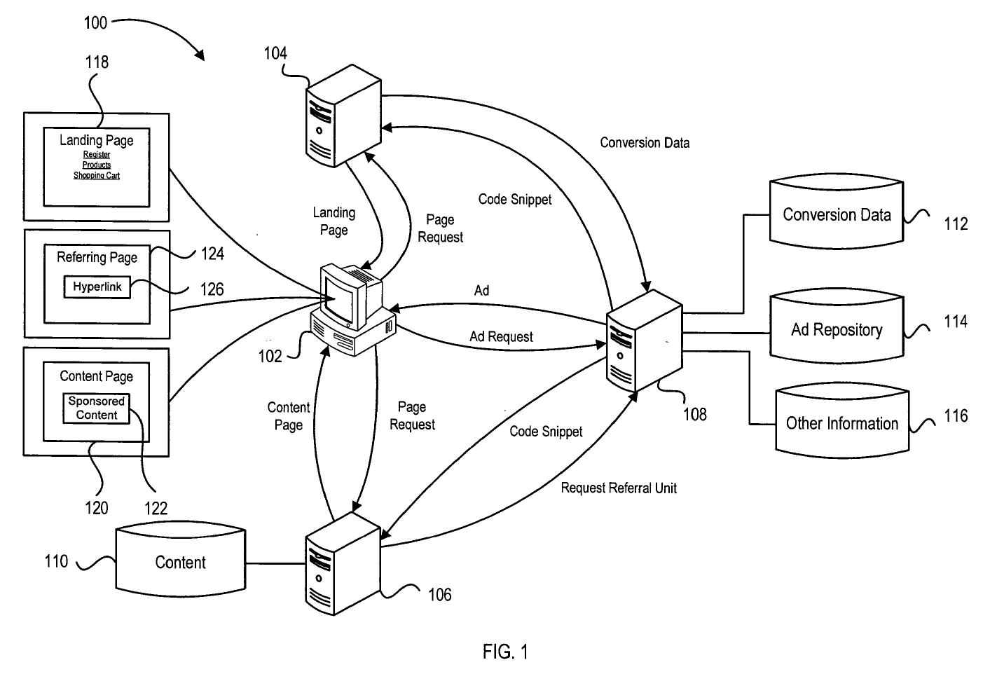

FIG. 1 is a block diagram showing an implementation of an online advertising system 100. In general, the system 100 can evaluate an ad context to retrieve sponsored content in a sponsored content repository. For example, the system 100 can evaluate a web page corresponding to a reference Universal Resource Locator (URL). In some implementations, the system 100 evaluates anchor content associated with a hyperlink used to transition from a web page to another web page to determine an ad context. Used herein, “anchor content” describes information associated with a hyperlink in a web page that transitions the user to another web page. For example, anchor content can include text (e.g., “Memory capacity increased in the latest line of flash memory”), an image (e.g., an image of a flash memory card), image metadata, other information, or combinations thereof. The system 100 can use the evaluated anchor content to determine appropriate sponsored content to retrieve from a sponsored content repository. For example, the system 100 can use the keywords “flash” and “memory” in the previous example to retrieve sponsored content relating to the sale of flash memory or other sponsored content relating to flash memory. In addition, the retrieved sponsored content can be displayed on a content page of a website. In some other implementations, a reference page that directs to a destination page where sponsored content may be displayed can be evaluated. For example, the reference page can be a page with a form (and the destination page is the page that is displayed when the form is submitted) or a page that automatically redirects to the destination page, for example. The system 100 evaluates content in the reference page to determine an ad context. The system 100 can use the evaluated reference page to determine appropriate sponsored content to retrieve from a sponsored content repository. In another implementation, user activity or behavior in a first page from which a user navigates to a second page (e.g., clicking on a hyperlink to the second page, filling in a form, etc.) and the content of the first page can be used to determine an ad context that can be used to select and provide sponsored content.

In some implementations, one or more advertisers 104 can directly, or indirectly, enter, maintain, and track sponsored content (e.g., advertisements) information in a sponsored content management system 108. The sponsored content can be stored in a repository 114 coupled to the system 108 (e.g., a MySQL® database). Used herein, “sponsored content” is also referred to as an “advertisement” or an “ad.” The ads may be in the form of graphical ads, banner ads, text only ads, image ads, audio ads, video ads, ads combining one of more of any of such components, etc. The ads may also include embedded information, such as embedded media, links, meta-information, and/or machine executable instructions. One or more publishers 106 may submit requests for ads to the system 108. The system 108 responds by sending ads to the requesting publisher 106 for placement on one or more of the publisher's web properties (e.g., websites and other network-distributed content). The ads can be placed with or embedded in the publisher's content (e.g., videos, articles, search results), which can be stored in a repository 110 at the publisher 106, and/or placed with content received from other sources (e.g., other publishers, advertisers).

Other entities, such as users 102 and advertisers 104, can provide usage information to the system 108, such as, for example, whether or not a conversion or click-through related to an ad has occurred. This usage information can include measured or observed user behavior related to ads that have been served or pages that have been visited. In some implementations, the system 108 performs financial transactions, such as crediting the publishers 106 and charging the advertisers 104 based on the usage information.

A computer network, such as a local area network (LAN), wide area network (WAN), the Internet, wireless network or a combination thereof, can connect the advertisers 104, the system 108, the publishers 106, and the users 102.

One example of a publisher 106 is a general content server that receives requests for content (e.g., articles, discussion threads, music, video, graphics, search results, web page listings, information feeds, etc.), and retrieves the requested content in response to the request. The content server may submit a request for ads to an ad server in the system 108. The ad request may include a number of ads desired. The ad request may also include content request information. The content request information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with one or more of the ads provided by the system 108. This combined content and ads can be sent to the user 102 that requested the content for presentation in a viewer (e.g., a browser or other content display system). The content server can transmit information about the ads back to the ad server, including information describing how, when, and/or where the ads are to be rendered (e.g., in HTML or JavaScript™).

The advertising management system 108 can serve publishers 106, such as content servers and search services. The system 108 permits serving of ads targeted to documents served by content servers. For example, a network or inter-network may include an ad server serving targeted ads in response to requests from a search service with ad spots for sale. Suppose that the inter-network is the World Wide Web. The search service crawls much or all of the content. Some of this content will include ad spots (also referred to as “inventory”) available. More specifically, one or more content servers may include one or more documents. Documents may include web pages, email, content, embedded information (e.g., embedded media), meta-information and machine executable instructions, and ad spots available. The ads inserted into ad spots in a document can vary each time the document is served. In some implementations, an ad context can be used to vary the document served. In one implementation, an ad context includes content from a reference page. For example, reference page 124 can include a hyperlink 126 that references and links to content page 120. Reference page 124 can be analyzed in conjunction with the hyperlink 126 to determine anchor content. In addition, the system 100 can evaluate the anchor content and provide ads based on the evaluation of the anchor content. As another example, reference page 124 can include a form that, when filled and submitted, directs to content page 120. The content of the reference page 124 with the form can be evaluated and ads can be provided for presentation in the content page 120 based on the evaluation of the content of the reference page 124.

In some implementations, a publisher 106 may login to the system 108 by providing a user name and password to the system 108. The login may occur, for example, through a web page and the login process may use encryption, such as secure Hypertext Transfer Protocol (HTTPS). The publisher 106 may select from a list of specific products and/or services (referred to here as referral items) to advertise at a publisher site. The list of referral items may be the result of a search initiated by the publisher user based on, for example, a keyword or category selection made by the publisher user. In another example, the publisher 106 may select one or more keywords and/or one or more referral item categories that the system 108 may use to automatically determine referral items. Alternatively, the publisher 106 may provide site content to the system 108 or the system 108 may retrieve site content from the publisher 106. The system 108 then may contextually determine referral items based on, for example, relevance of referral items to the publisher site content.

In another example, the system 108 may determine referral items based on behaviors of the end user. For example, the system 108 can evaluate anchor content and generate referral categories, referral keywords, or combinations thereof. As another example, referral items can include results provided from a particular search query performed on a search engine website, or items based on a geographical location of the end user, such as products/services for businesses located near the end user. In addition, a combination of the examples for determining referral items described above may be used.

In some implementations, the publisher 106 may select particular ads (referred to here as referral units) associated with a determined referral item to present on a publisher web site. Ads may include, for example, text links, images, audio, video, or other media and may be formatted, for example, in a banner/horizontal orientation or a sidebar/vertical orientation. In this example, the publisher 106 selects the referral units to present at the publisher web site. Alternatively, the system 108 may select appropriate referral units based on, for example, anchor content associated with a hyperlink selected to transition from a reference page 124 to content page 120. In addition, the system 108 may rotate the selected referral unit from a list of referral units. In FIG. 1, the publisher 106 selected an ad 122 for a content page 120.

In some implementations, the publisher 106 receives one or more code snippets, each associated with a selected referral unit. Each code snippet can include a signed or encoded specification of the referral ad(s) determined by the publisher 106. For example, the publisher 106 may receive a code snippet, from the system 108, associated with a selected referral unit, such as a banner ad for an MP3 (MPEG-1 Audio Layer 3) music player. In some implementations, the code snippet includes a specification corresponding to the selected ad(s) that associate with a set of conversion actions (e.g., purchasing the MP3 player, subscription to a mailing list) which may result from interaction with the ad by a user 102 (e.g., a clickthrough). In other implementations, when the ads that are eligible for a particular set of conversion actions are known by the system 108, the specification can be omitted from the code snippet. When a conversion occurs, the conversion action allows the system 108 to determine how much the publisher 106 is credited resulting from showing the ad at the publisher web site.

In some implementations, one or more code snippets can be added to web page code of the publisher 106. For example, the publisher 106 may add the banner ad code snippet to the publisher web page. In some implementations, the code snippet is a web script, such as JavaScript™. The execution of the code snippet by the user 102 results in a contact with the system 108 and the display of the ad to the user 102. When the user 102 clicks on the displayed ad, the system 108 is contacted again, and the user 102 is redirected to a landing page 118 of the advertiser's web site. During this event the user 102 can receive a signed browser cookie from the system 108. In some implementations, tampering with the contents of the signed cookie invalidates conversion actions associated with the cookie. The cookie can include information, such as an identifier of the MP3 player banner ad, an identifier of the publisher 106, and the date/time the banner ad was selected by the user 102. The cookie can then be used together with information associated with conversion actions performed at the advertiser 104 by the user 102 to credit the publisher 106 and debit the advertiser 104.

In some implementations, an advertiser 104 may login to the system 108 by providing a user name and password to the system 108. The login may occur, for example, through a web page and the login process may use encryption, such as secure Hypertext Transfer Protocol (HTTPS).

Once logged in, the advertiser 104 may select a conversion type from a list provided by the system 108, or make an input including a new conversion type. Each conversion type corresponds to a conversion action that the user 102 may perform, such as a purchase of a product or service, a selection of a banner ad (click-through) or other action.

In some implementations, the advertiser 104 may input description information to the system 104 to assist the publishers 106 in determining referral units to publish.

In some implementations, the advertiser 104 may input a cost/value associated with the selected conversion type, such as a 5 dollar credit to the publisher 106 for each product or service purchased.

In some implementations, the advertiser 104 may create a banner ad that the publisher 106 provides the user 102.

In some implementations, a code snippet includes one or more signed conversion type identifiers (IDs), for insertion in a confirmation page script. For example, the system 108 can generate a signed conversion type identifier associated with the selected conversion type, the specified cost per conversion, and the created referral unit. The system 108 transmits the signed conversion type identifier to the advertiser 104 within a code snippet.

In some implementations, the user 102 can select a particular banner ad at the publisher 106. The publisher code snippet directs the user 102 to the system 108 from which a signed browser cookie is retrieved. The user 102 is then directed to a web page at the advertiser 104. The user 102 performs a conversion action at the advertiser 104, such as purchasing a product or service, registering, joining a mailing list, etc. The advertiser code snippet can be included within a conversion confirmation page script, such as a script within a web page presented after the purchase. The user 102 executes the advertiser code snippet. The advertiser code snippet contacts the system 108 and reports the conversion type identifier from the advertiser code snippet as well as information from the cookie, such as a publisher identifier, a referral unit identifier, and a date/time of the referral unit impression and click. In some implementations, conversion data (e.g., number and types of conversions) can be stored in a repository 112, where it can be used by the system 108 to improve ad targeting performance.

In some implementations, the advertiser code snippet may be executed from a conversion confirmation web page indicating that the user 102 performed a conversion action.

In some implementations, the advertiser code snippet may retrieve a referral unit identifier, a publisher identifier, and a date/time of the referral unit impression and click from a cookie located at the user 102. The advertiser code snippet can include the conversion type identifier associated with the conversion action performed by the user 102.

In some implementations, the advertiser code snippet, executing at the user 102, transmits the identified conversion parameters to the system 108.

In some implementations, the advertiser code snippet, executing at the user 102, transmits the identified conversion parameters to the advertiser 104. The advertiser 104 accumulates the conversion parameters and periodically transmits them to the system 108. Moreover, the advertiser code snippet can transmit an identifier of the reference page (e.g., the URL of the reference page) to the system 108.

In some implementations, other types of data can be collected by the system 108 and stored in a repository 116. Such data may include, for example, anchor content used to transition between various content pages, personal profiles of users, geographic locations of users, an ad context, etc. All or some of this information can be used to improve ad targeting performance.

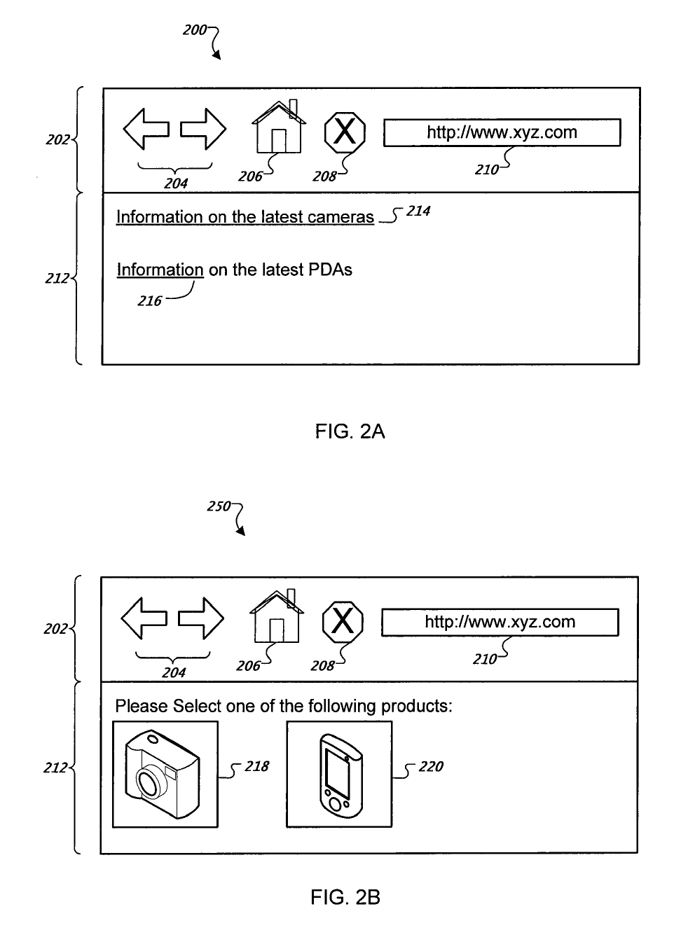

FIGS. 2A and 2B are screenshots of web browsers 200 and 250 showing examples of anchor content. In general, the web browsers 200 and 250 include a navigation area 202 and a view area 212. The navigation area 202 can be used to visit one or more web pages, and the view area 212 can display the visited content. The navigation area 202 includes forward and back arrows 204, a button 206 that can return the user to a predefined web page, a button 208 that can stop a page from being loaded, and a text area 210 for entering a URL. The navigation area 202 can also include various other user interface components, such as a refresh button, a search bar, or other user interface components.

The view area 212 can display content specified by HTML, or other languages used in the construction of web pages. In addition, the browser area 212 allows a user to interact with regions of the web page. For example, the user can click on a hyperlink (which can be displayed as text or an image in the view area 212, depending on the nature of the anchor content associated with the hyperlink) to navigate to the page referenced by the hyperlink and view the content of that page. By clicking on the hyperlink, a HTTP request can be generated and directed to a web server, where the request is processed and code corresponding to the new web page is delivered to the web browser for display. In some implementations, the HTTP request includes the referral information describing the location of the request (e.g., the referer field in the HTTP request that specifies the location from which the URL to the new web page was obtained).

Referring to FIG. 2A, examples of anchor text are shown. Anchor text can be associated with a hyperlink or other click-enabled text. For example, anchor text 214 “Information on the latest cameras” is a hyperlink. When a user clicks on the anchor text 214, a reference URL is generated from the URL in text area 210 (e.g., “http://www.xyz.com”). In addition, the anchor text 214 and the reference URL are included in an HTTP request that is sent to a web server that contains the web page corresponding to the web page referenced by anchor text 214. In an implementation, the reference URL in the text area 210 is used as the referrer URL in the HTTP request. In addition, the system 108 evaluates the anchor text to determine an ad context. In this case, the ad context is substantially similar to the anchor text. As another example, anchor text 216 “Information” is also a hyperlink. When a user clicks on anchor text 216, in addition, to the steps described in the previous example, the system 108 can determine additional ad context information using content in proximity to the hyperlink (e.g., words before and/or after the hyperlink). For example, the word “PDAs” is in close proximity to the anchor text “Information,” and can be used to determine an ad context.

Referring to FIG. 2B, examples of anchor images are shown. As with the anchor text examples, the anchor images are clickable interface components in a web page. When a user clicks on an image, the image can be analyzed in a variety of ways. For example, the image can be compared to an image database to determine the type of object represented in the image to determine an ad context. As another example, the metadata associated with the image can be evaluated to determine an ad context. For example, the title of the image 218 may include a product name such as “Camera 1212.” In this case, the product name can be used to determine an ad context. As another example, the date of the image can be used to determine an ad context. In the previous examples, the determined ad context can be used to improve the performance of the ad targeting. For example, a set of ads relating to cameras can be targeted to the user, instead of a superset of all possible ads associated with a publisher's website.

In some implementations, when the forward or backward arrows 204 are used, cached information can be associated with the HTTP request that is used to provide an ad context. For example, consider web page A that includes anchor content AA. If a user selects anchor content AA to transition to web page B during the course of browsing web pages, and then the user returns to B at a later point in time by using the back arrow, the cached anchor content AA used in the original transition to B can be used to determine the ad context for web page B.

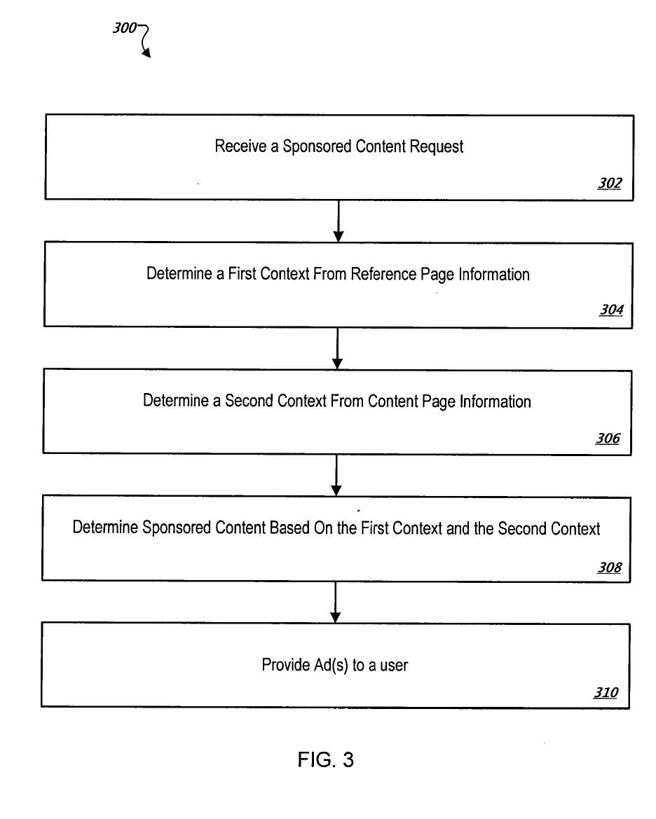

FIG. 3 is a flow diagram of an example ad targeting process 300. The steps of process 300 do not have to occur in a specific order and at least some steps can occur in parallel. In general, the ad targeting process 300 uses an ad context to improve the performance of ad targeting.

The ad targeting process 300 begins when a sponsored content request is received from a user system (302). The sponsored content request can include a reference URL of a referring web page (e.g., reference page 124) which can be used (e.g., crawled by a context server) to determine a first ad context (304). In some implementations, the sponsored content request can include a URL of the web page (e.g., content page 120) which can be used (e.g., crawled by a context server) to determine a second ad context (306). Both web pages can be crawled on a scheduled basis or in response to a trigger event. The context server processes the content using, for example, a clustering algorithm. The clustering algorithm identifies clusters associated with key features or traits that can be used to determine an ad context. If the web page was not previously crawled, the page can be crawled in real-time by a crawler. An example of a crawler is described in Brin and Page, “The Anatomy of A Large-Scale Hypertextual Web Search Engine,” Computer Networks and ISDN Systems, Vol. 30, Issues 1-7, pages 107-117 (April 1998), which is incorporated by reference herein in its entirety.

Using the first ad context and the second ad context, targeted ads can be retrieved from an ad repository (308). This can be accomplished by weighting the two context values, generating a composite ad context. The composite ad context can be used to determining which ads fall into the composite ad context and which advertisers associated with those contextually relevant ads have been approved for display by the publisher. One or more of these relevant ads can be selected (e.g., by the system 108) and delivered (e.g., to the user system 102) for presentation on a display device (e.g., of the user system 102) (310).

The targeted ads can be displayed on the web page that includes the targeted content or the ads can be provided using a different communication medium, such as an email message or instant message. The ads can be delivered to the user system while the user is viewing the web page with the targeted content.

In some implementations, an ad auction can be run to determine the best N ads, and only those N ads are shown to the user. In some cases, the best N ads could be the top N advertisers, for example.

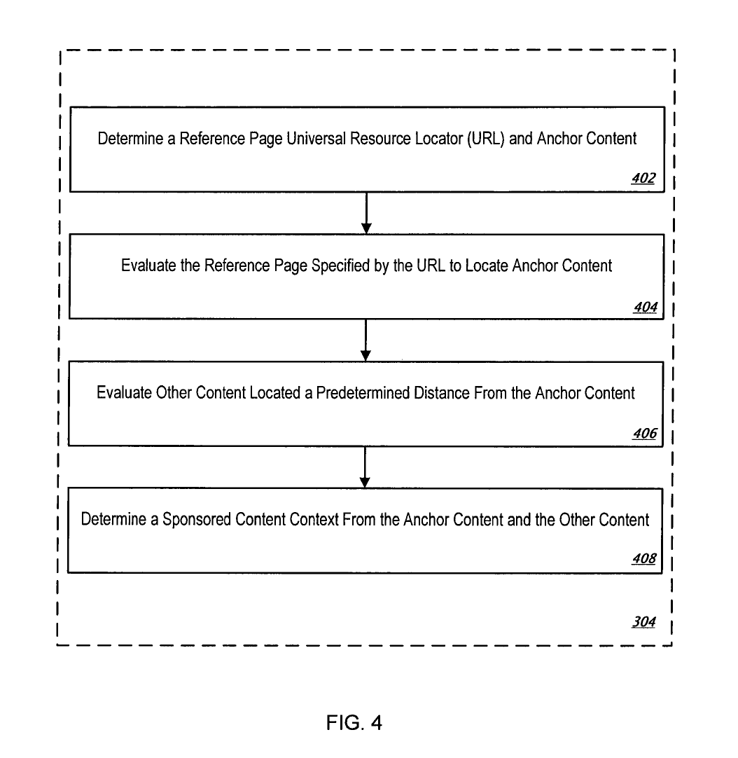

FIG. 4 is a flow diagram of an example context evaluating process 400. The steps of process 400 are illustrated as sub-steps of step 304 in process 300. However, one or more steps of process 400 may be used by other steps of process 300. Moreover, the steps of process 400 do not have to occur in a specific order and at least some steps can occur in parallel. In general, the context evaluating process 400 locates anchor content in a reference page, and determines a context from the anchor content and other content located a predetermined distance from the anchor content.

The context evaluating process 400 begins by determining a reference URL and anchor content (402). In some implementations, the reference URL is associated with a request for a content page. For example, if a user is currently viewing “www.xyz.com” and clicks on a hyperlink to access a new page, the reference URL is “http://www.xyz.com.” The reference URL can be determined by using a parser to parse the referer field of an HTTP request, for example.

The reference page can be evaluated (e.g., crawled by a context server) to locate the anchor content (404). Once the anchor content has been located, a predetermined area around the anchor content can be evaluated (406). For example, in some implementations, additional text is evaluated by looking at the five words preceding and/or succeeding (e.g., to the right and/or left) of the anchor content.

The anchor content and the content in the predetermined area around the anchor content can be used to determine a sponsored content context (408). For example, the sentence “Click here for additional information on cameras,” where “here” is the anchor content provides additional content of “cameras.” The content “cameras” can be used to generate one or more categories and/or keywords relating to appropriate sponsored content. Theses categories and/or keywords can be used to access the sponsored content repository (e.g., repository 114) and retrieve the most relevant ads.

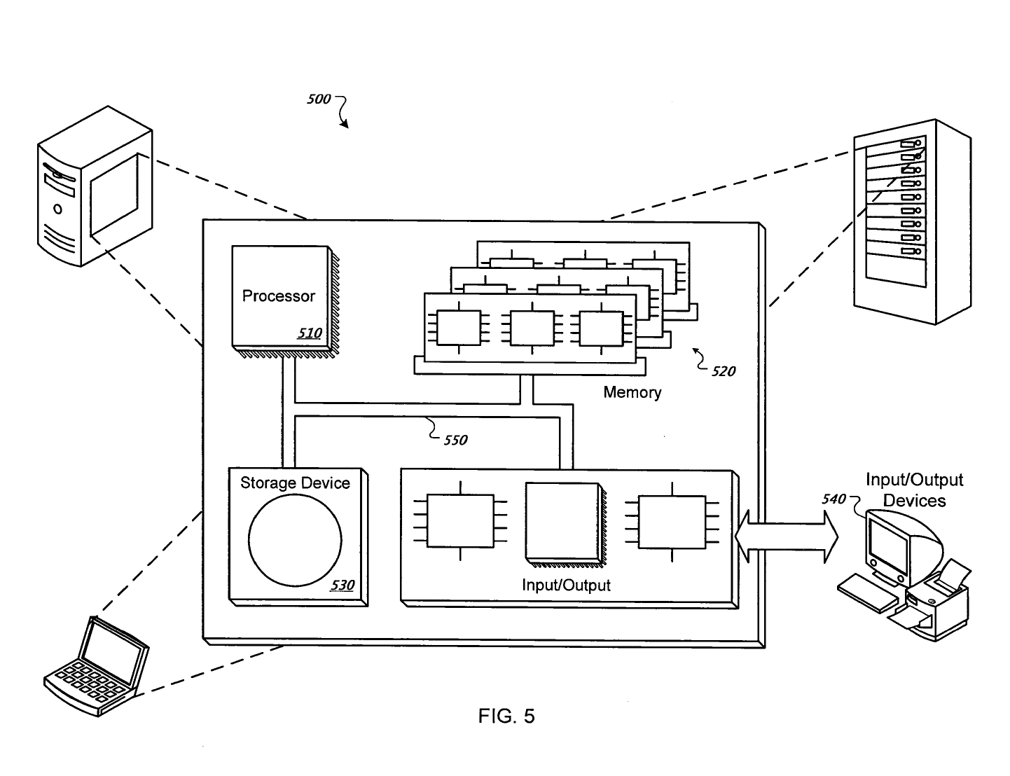

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The disclosed and other implementations and the functional operations described in this specification can be implemented in digital electronic circuitry, or in computer software, firmware, or hardware, including the structures disclosed in this specification and their structural equivalents, or in combinations of one or more of them. The disclosed and other implementations can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed implementations can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed implementations can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations have been described. Other implementations are within the scope of the following claims. For example, while the discussion above makes reference to anchor content in context of a webpage and navigation path associated with web implementation, other implementations are possible.

What is claimed is:

1. A method comprising:
receiving a request for providing sponsored content to be associated with source content provided by a page publisher;
evaluating a source of a referral to the source content; and
selecting the sponsored content based on the evaluation.

2. The method of claim 1 wherein evaluating the source of the referral to the source content includes evaluating content of a page in which the referral to the source content is located.

3. The method of claim 1 wherein evaluating the source of the referral to the source content includes evaluating anchor content associated with the referral to the source content.

4. The method of claim 2 wherein the anchor content is anchor text.

5. The method of claim 2 wherein the anchor content comprises an anchor image.

6. The method of claim 2 further comprising evaluating content in proximity to the anchor content.

7. The method of claim 5 wherein the content in proximity to the anchor content is text, and the method further comprising evaluating text that is a predetermined distance from a location associated with the anchor content.

8. The method of claim 7 where the predetermined distance is a predetermined number of words in a same line.

9. The method of claim 7 where the predetermined distance is a predetermined number of words in a same sentence.

10. The method of claim 7 wherein the predetermined distance is a predetermined number of characters before or after the anchor content.

11. The method of claim 10 wherein the predetermined number of characters is 5.

12. The method of claim 7, wherein the predetermined distance is a predetermined number of words before or after the anchor content.

13. The method of claim 12, wherein the predetermined number of words is 5.

14. The method of claim 2 wherein evaluating the source of a referral to the source content includes evaluating metadata associated with the anchor content.

15. The method of claim 1 further comprising evaluating the source content and wherein the step of selecting sponsored content includes using both evaluations to select the sponsored content.

16. The method of claim 15 wherein a result of an evaluation of the source content and a result of an evaluation of the source of the referral to the source content are weighted to determine a selection.

17. The method of claim 15 further comprising using a result of the evaluation of the source of the referral to the source content along with one or more other criteria to select sponsored content.

18. The method of claim 17 wherein the other criteria are defined by the page publisher.

19. The method of claim 17 wherein the other criteria are defined by the sponsored content provider.

20. A method comprising:
sourcing content source material including one or more portions therein available to be populated by sponsored content;
embedding within the content source material a call to a sponsored content server;
causing to be delivered to the sponsored content server an identifier for a content source material requester and information related to a referrer of the content source material to the content source material requester; and
responding to a page request to deliver the content source material including providing the content source material including the embedded call to the content source material requestor.

21. A method comprising:
requesting content from a publisher including providing a content request to the publisher, the content request including sourcing information indicating a context of the requestor; and
receiving and displaying the content from the publisher and sponsored content that is selected at least in part based on the sourcing information.

22. The method of claim 21 wherein the sourcing information includes anchor content.

23. The method of claim 22 wherein the sourcing information includes content in proximity to the anchor content.

24. The method of claim 22 wherein the anchor content includes anchor text.

25. The method of claim 24 wherein the sourcing information includes text in proximity to the anchor text.
